(19) United States
(12) Patent Application Publication
(10) Pub. No.: US 2005/0009964 A1
(43) Pub. Date: Jan. 13, 2005

(54) Photochromic plate containing melanin

(75) Inventors: Hideyo Sugimura, North Oaks, MN (US); Michael S. Boulineau, Forest Lake, MN (US); Xuzhi Qin, Hacienda Heights, CA (US)

Correspondence Address: INSKEEP INTELLECTUAL PROPERTY GROUP, INC, 1225 W. 190TH STREET, SUITE 205, GARDENA, CA, 90248, US

(73) Assignee: Vision-Ease Lens, Inc.

(21) Appl. No.: 10/850,228

(22) Filed: May 19, 2004

Related U.S. Application Data
(60) Provisional application No. 60/472,029, filed on May 19, 2003.

(51) Int. Cl. C08K 5/15; B32B 27/00

(52) U.S. Cl. 524/110; 428/423.1

(57) ABSTRACT

A photochromic melanin-containing optical plate is described. The plate has a lamination structure comprising one or two functional film layers containing photochromic compounds and melanin pigments. The photochromic melanin-containing optical plate absorbs high-energy visible-light while indoor and darkens to a sunscreen while outdoors. The plate can be advantageously used in eyewear optical articles such as ski goggles, sunscreen lenses, eyewear lenses, etc.

### CROSS REFERENCE TO RELATED APPLICATIONS

This application claims the benefit of priority from U.S. Provisional Application Ser. No. 60/472,029 entitled Photochromic Melanin-Containing Plate And It's Use In Plastic Optical Articles, filed on May 19, 2003; the contents of which is herein incorporated by reference.

### BACKGROUND OF THE INVENTION

1. Field of the Invention

The current invention concerns a transparent plate that contains both melanin and photochromic dyes, the process to make it, and its use in eyewear optical articles, including ski goggles, sunscreen lenses, eyewear lenses.

2. Background of the Invention

Melanin is known for its use as a pigment to provide a naturally appearing tan and a sunscreen to mammalian skin and hair. In recent years, increased attention has been given to the application of melanin for providing full spectrum (ultraviolet, visible and near infrared) absorption properties to protective eyewear.

It is well known that long-term exposure to UVB (290-315 nm) and UVA (315-380 nm) is harmful to human eyes as well as human skin. Not as well known is the fact that intense HEV (high energy visible light), light of wavelength 380-500 nm is also implicated in causing damage to the eye. In the outdoor environment, there is on average twice the intensity from solar radiation of the HEV component than UV component. HEV is particularly toxic to the aging retina because it has lost antioxidant protection (Roberts, J. E., “Hazards of sunlight exposure to the eye”, in Sun Protection in Man, (2001) pp 155-174).

Melanin provides an optimum absorption spectrum for blocking the HEV. Ordinary eyewear lenses only cut off the ultraviolet radiation below 400 nm. A lens with melanin incorporated therein provides excellent absorption at the wavelength range of HEV without sacrificing color perception. The application of melanin as absorbing pigment against radiation emitted by artificial and natural light sources is specifically disclosed in a series of U.S. Pat. Pat. Nos. 4,698,374, 5,036,115, 5,047,447, and 5,112,883 all of which are incorporated herein by reference.

When melanin lenses are made for indoor use to block the HEV from light sources like fluorescent bulbs, the visible light transmission of the lenses are preferably between 60% to 80%. In this range, the lenses provide necessary block-off of HEV, and reduce eyestrain, while keeping the comfortable vision. However, the light transmission suitable for indoor use is too high for outdoor use. To effectively cut glares of sunlight and to protect eyes from intensive HEV, a much lower light transmission is needed. Suitable light transmission for lenses used as outdoor sunscreen is preferably between 10% to 40%.

It is desirable to have a melanin-containing eyewear lens that has variable light transmission depending on the light condition. Such a lens will act like an ordinary melanin-containing HEV filter when staying indoors. When staying outdoors, the lens will have a lower light transmission and acts as a sunscreen and a HEV blocker.

U.S. Pat. No. 6,328,446 (herein incorporated by reference), discloses an insert injection molding method to manufacture eyewear lenses with special functions such as polarizing or photochromism, by using functional plate or film insert. An eyewear lens with both melanin and photochromic functions can also be made in the same manner if a melanin-containing plate having variable light transmission is readily available.

### SUMMARY OF THE INVENTION

It is thus the object of this invention to provide a melanin plate having variable light transmission. Such a plate can then be conveniently used to make not only eyewear lenses but also other optical articles such as sport goggles, window sheets, etc.

The variable light transmission function is provided by the addition of photochromic dyes into the melanin plate. The object is achieved by having a transparent plate that is a lamination structure comprising one or two functional film/sheet layers containing at least one photochromic dye and at least one melanin pigment.

The first technical aspect of the invention involves a transparent optical plate having a functional film/sheet layer in which a photochromic dye and a melanin pigment co-exist. At least one transparent resinous sheet layer is bonded to one side of the functional layer, with or without adhesive or binder layer, to protect or support said functional layer.

The second technical aspect of the invention involves a transparent optical plate having two functional film/sheet layers. One of the two functional layers is photochromic, and the other of the two functional layers contains melanin for HEV filtering. When the transparent optical plate having said functional layers is incorporated in a plastic optical article such as an eyewear lens, the photochromic layer is facing the incident light. At least one transparent resinous sheet layer is bonded to one outer side of the two functional layers, with or without adhesive or binder layer, to protect or support said functional layers.

The melanin-containing plate having variable light transmission due to photochromism according to the present invention can be used as-is in goggles, or incorporated into other plastic optical articles such as an eyewear lens through insert injection molding or resin casting methods. In the case of an eyewear lens, the visible light transmission of the lens is preferably between 60% to 80% when staying indoors, and preferably between 10% to 40% when staying outdoors. Such a lens will act like an ordinary melanin0containing HEV filter to filter off the HEV from light sources like fluorescent bulbs when staying indoors. When staying outdoors, under the effect of solar radiation, the photochromic dyes will darken and turn the article into a sunscreen. At the same time, the article is still effective in blocking HEV. The lens can also be advantageously used in other applications such as a driving lens at night time or a computer lens.

The terms “sheet”, “layer”, and “film” are used interchangeably within this application.

### DETAILED DESCRIPTION OF THE INVENTION

The melanin used in this invention for providing HEV blocking property can be either hydrophobic or hydrophilic (water-soluble). For the purpose of the present description, melanins are defined and classified as in the book entitled Melanins, by R. A. Nicolaus, published in 1968 by Hermann, 115, Boulevard Saint-Germain, Paris, France (hereinafter “Nicolaus”) which work in its entirety is incorporated herein by reference. As defined by Nicolaus, melanins constitute a class of pigments which are widespread in the animal and vegetable kingdoms. Melanins are macromolecules consisting of mixtures of polymers that are highly conjugated in nature. The extensive degree of conjugation produces their unique transmittance spectrum. Melanins are highly irregular, three-dimensional polymers not only in the way monomeric units are linked together but in the nature of the units themselves. A typical melanin structure is shown in Arnaud, R., et al, Photochem Photobiol, Vol. 38, page 161-168 (1983), Electron Spin Resonance of Melanin from Hair, Effects of Temperature, pH, and Light Irradiation. While the name melanin in Greek means black, not all melanins as pigments are black but may vary from brown to yellow.

Melanins are classified in three groups, namely, eumelanins, phaeomelanins and allomelanins. Eumelanins are derived from the precursor tyrosine shown as compound (1):

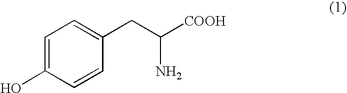

Phaeomelanins are derived from the precursors tyrosine or cysteine shown as compound (2):

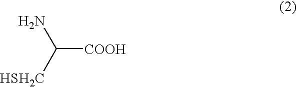

Allomelanins, the meaning of which is other melanins, are formed from nitrogen-free precursors, such as catechol. It is also believed that 1,8-dihydroxynapthalene may produce melanin through enzymatic oxidation. Further information on Melanins is found and incorporated herein by reference on page 827, Monograph No. 5629 in The Merck Index (10th Ed. 1983).

Melanin is produced in nature by the oxidative polymerization of the precursors. Furthermore,.melanin may be synthesized commercially or in the laboratory from precursors through the free radical polymerization of these precursors. An example of the synthetically produced catechol melanin and DOPA melanin are found in the article by Froncisz, W., Sarna, T., Hyde, James S. Arch. Biochem. Biophys. “Copper (2+) ion Probe of Metal-ion Binding Sites in Melanin Using Electron Paramagnetic Resonance Spectroscopy.” I. Synthetic Melanins. (1980, 202(1), 289-303). That article is incorporated herein by reference.

Additional information relative to the preparation of suitable water-soluble allomelanins may be found in U.S. Pat. No. 5,112,883 and the documents incorporated therein, all incorporated herein by reference.

Convenient synthesis of water-soluble hydrophilic eumelanins can be found in a series of U.S. Pat. Nos. 5,216,116, 5,218,079, 5,225,435, 5,227,459, 5,384,116, and 5,618,519. They are all incorporated herein by reference.

This invention is directed to the use of any melanin regardless of its source or method of preparation. Therefore, natural, synthetically prepared or any other melanin may be used in accordance with the present invention as an absorbing pigment or dyeing pigment.

Suitable photochromic dyes in the context of the invention are organic compounds that, in “solution” state, are activated (darken) when exposed to a certain radiation energy (e.g., outdoor sunlight), and bleach to clear when the light energy is removed. They are selected from the group consisting of benzopyrans, naphthopyrans, spirobenzopyrans, spironaphthopyrans, spirobenzoxzines, spironaphthoxazines, fulgides and fulgimides. Such photochromic compounds have been reported in a rich amount of patents and literature including U.S. Pat. Nos. 5,658,502, 5,702,645, 5,840,926, 6,096,246, 6,113,812, and 6,296,785 (all incorporated herein by reference).

Among the above photochromic compounds, naphthopyran derivatives are preferred for optical articles such as eyewear lenses. They have good quantum efficiency for coloring, a good sensitivity and saturated optical density, acceptable bleach or fade rate, and most importantly good fatigue behavior. These compounds are available to cover the visible light spectrum from 400 to 700 nm. Thus, it is possible to obtain a desired blending color, such as gray or brown, by mixing two or more photochromic compounds who have complementary colors under an activated state.

More preferred are naphtho[2,1b]pyrans and naphtho[1,2b]pyrans represented by the following generic formula:

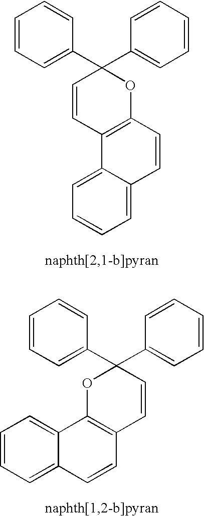

Substituents on various positions of the aromatic structure are used to tune the compounds to have desired color and fading rate, and improved fatigue behavior.

This invention is directed to the use of not only organic photochromic compounds that can be dissolved in hydrophobic polymeric host material, but also those compounds that are soluble in water. Example water-soluble photochromic compounds are disclosed in U.S. Pat. No. 6,211,374, incorporated herein by reference.

A photochromic dye may contain a polymerizable group such as a (metha)acryloiloxy group or a (metha)allyl group, so that it can be chemically bonded to the host material through polymerization.

Considering the color of most melanin pigments is brown, it is preferred to use a photochromic formulation that produces a brown color after activation. Such brown formulation may contain a single brown coloring photochromic dye, or a combination of several complementary dyes, e.g., a combination of yellow, red, and blue photochromic dyes. Example single brown coloring photochromic dyes are disclosed in U.S. Pat. No. 6,296,785 and U.S. Patent Application Ser. No. 60/421,348. Example brown photochromic compositions are disclosed in U.S. Pat. Nos. 5,753,146 and 6,141,135. They are incorporated herein by reference.

According to a first technical aspect of the invention, a transparent optical plate has a functional film/sheet layer in which photochromic and melanin dyes co-exist. For hydrophobic photochromic dyes and melanin pigments, it is desired to use a hydrophobic polymeric material as the film/sheet layer host. For hydrophilic (water-soluble) photochromic and melanin dyes it is desired to use a hydrophilic polymeric material as the layer host.

In selecting the host material, more consideration is given to the photochromic performance, such as the fading rate, color intensity, and fatigue behavior. The host material will usually be transparent, but may be translucent or even opaque. The host material need only be pervious to that portion of the electromagnetic spectrum, which activates the photochromic substance, i.e., that wavelength of ultraviolet (UV) light that produces the open or colored form of the substance and that portion of the visible spectrum that includes the absorption maximum wavelength of the substance in its UV activated state. Preferably, the host color should not be such that it masks the color of the activated form of the photochromic compounds, i.e., so the change in color is readily apparent to the observer. Most preferably, the polymeric organic host material is a solid transparent or optically clear thermoplastic material, e.g., materials suitable for optical applications, such as ophthalmic eyewear lenses, and is formable to accommodate the shape of the optical articles.

Examples of polymeric organic host materials which may be used with the hydrophobic photochromic compounds and melanin pigments described herein include: polymers (homopolymers and copolymers) of the bis(allyl carbonate) monomers, diethylene glycol dimethacrylate monomers diisopropenyl benzene monomers, ethoxylated bisphenol A dimethacrylate monomers, ethylene glycol bismethacrylate monomers, poly(ethylene glycol) bismethacrylate monomers, ethoxylated phenol bismethacrylate monomers, alkoxylated polyhydric alcohol acrylate monomers, such as ethoxylated trimethylol propane triacrylate monomers, urethane acrylate monomers, and vinylbenzene monomers, and styrene; polymers (homopolymers and copolymers) of mono- or polyfunctional, e.g., di- or multi-functional, acrylate and/or methacrylate monomers, poly(C₁-C₁₂ alkyl methacrylates), such as poly(methyl methacrylate), poly(oxyalkylene)dimethacrylate, poly(alkoxylated phenol methacrylates), cellulose acetate, cellulose triacetate, cellulose acetate propionate, cellulose acetate butyrate, poly(vinyl acetate), poly(vinyl alcohol), poly(vinyl chloride), poly(vinylidene chloride), polyanhydrides, polyurethanes (both thermoplastic and thermoset), polythiourethanes, polystyrene, poly(alpha methylstyrene), copoly(styrene-methyl methacrylate), copoly(styrene-acrylonitrile), polyvinylbutyral and polymers, i.e., homopolymers and copolymers, of diallylidene pentaerythritol, particularly copolymers with polyol (allyl carbonate) monomers, e.g., diethylene glycol bis(allyl carbonate), and acrylate monomers, e.g., ethyl acrylate, butyl acrylate. Blends of compatible transparent polymers are also suitable as host materials. Thermoplastic polyurethane materials, thermoset polyurethane materials, and polyurethanes made from two-component systems are especially preferred for hosting hydrophobic photochromic compounds and hydrophobic melanin pigments.

There are many methods available for ones skilled in the art to incorporate hydrophobic photochromic dyes and melanin pigments into a host material. Such methods include hot-mixing (kneading)/extruding, solution-casting, coating, and impregnating (diffusing), etc. Among them, hot-mixing is less preferred due to possible thermal degradation to the dyes.

The thickness of the photochromic melanin-containing hydrophobic film/sheet is preferably between about 15 microns to 1 mm, more preferably between about 30 microns to 100 microns.

Example hydrophilic polymer materials that can be used to host water-soluble or dispersible photochromic compounds and melanin pigments include polyvinyl alcohol type polymers, polyvinyl formal polymer, polyvinyl acetal polymer, polyvinyl pyrrolidone type polymers, and sulfonated polyesters, such as those describe in U.S. Pat. No. 5,427,835, incorporated herein by reference.

Polyvinyl alcohol (PVA) is the most preferred host material. More specifically, water-soluble photochromic compounds and melanin pigments are incorporated into polyvinyl alcohol host film/sheet through absorbing or diffusing method. The polyvinyl alcohol-type film used in this invention may have a thickness between 15 to 150 microns, preferably 30 to 100 microns. Example polyvinyl alcohol films are Kurare Vinylon® of Kuraray Inc., KODACEL® of Kodak, and Elvanol® of DuPont.

A PVA film of this invention, containing water-soluble photochromic compounds and melanin pigments can also be prepared with a solution casting method, in which aqueous solution of PVA with predetermined concentration of water-soluble photochromic compounds and melanin pigments is cast on a releasable substrate. The cast film is obtained after the evaporation of water.

In a first technical aspect of this invention, at least one transparent resinous sheet is bonded, with or without adhesive or binder layer, to one side of the photochromic melanin-containing functional film as a protective or support layer. Preferably two transparent resinous sheets are bonded to the two sides of the functional film. Said transparent resinous sheets mainly serves to add a practical function, for example, to protect the dye-containing film, or to provide a strength or retention of shape of a transparent optical article. It is preferable that the resin sheet has a high transparency, a great workability for heating and forming, and an excellent bonding property to the dye-containing functional film. While a thickness is not particularly restricted, it is usually 2 mm or less, preferably 1 mm or less. It is further preferable that the resinous sheet material is the same as the base body material of the optical article that the photochromic melanin-containing optical plate of this invention will be incorporated into, so that the optical plate and the optical article body can be excellently integrated together by using methods such as insert injection molding.

Example resin materials to be used for the transparent resinous sheet layer according to the invention are those polymer host materials aforementioned for hydrophobic photochromic compounds and melanin pigments. In particular, the thermoplastic resin to be used suitably in the invention is the polycarbonate-based resin because of a high transparency, a high tenacity, a high thermal resistance and a high refractive index. A typical polycarbonate based resin is polybisphenol-A carbonate. In addition, examples of the polycarbonate based resin include homopolycarbonate such as 1,1′-dihydroxydiphenyl-phenylmethylmethane, 1,1′-dihydroxydiphenyl-diphenylmethane, 1,1′-dihydroxy-3,3′-dimethyldiphe-nyl-2,2-propane, their mutual copolymer polycarbonate and copolymer polycarbonate with bisphenol-A.

In case that the host material for the photochromic melanin-containing functional film is a thermoplastic polyurethane, it can be bonded to the transparent resinous sheet through hot-press without additional adhesive or binding material. A polyurethane host layer may also be made from liquid raw materials such as a 2-component polyurethane system. For other host materials, it is usually desirable to use an adhesive and a binding material to bond the functional film/sheet and the resinous sheet. Examples of the adhesive include an isocyanate based adhesive, a polyurethane based adhesive, a polythiourethane based adhesive, an epoxy based adhesive, a vinyl acetate based adhesive, an acryl based adhesive and a wax based adhesive. Examples of the binder include a vinyl acetate based binder and an acryl based binder. The thickness of the adhesive or binder is usually 1 to 200 microns.

In some cases, the surfaces of the film or sheets are subjected to a chemical solution treatment using acid or alkali, an ultraviolet treatment, or a plasma or corona discharge treatment in bonding or binding process in order to enhance the adhesion.

According to the second technical aspect of the invention, a transparent optical plate has two functional film/sheet layers. One of the two functional layers is photochromic, and the other of the two functional layers contains melanin for HEV filtering. The functional layers are independently hosted by hydrophobic polymers or hydrophilic polymers, and they can be optionally protected or supported by other transparent resinous sheets. When the transparent optical plate having said functional layers is incorporated in a plastic optical article such as an eyewear lens, the photochromic layer is preferably facing the incident light so that the activation of the photochromic compounds will not be impaired by the absorption of UV light by melanin pigments.

The materials, methods of incorporating dyes, specifications in the first technical aspect of the invention can be used in the second technical aspect of the invention. The second technical aspect of the invention provides more flexibility in preparing a photochromic melanin-containing optical plate. By incorporating the photochromic compounds and melanin pigments in separate host layers, one can choose the best suitable host material for each of them. For example, most photochromic compounds are hydrophobic (not dissolving in water) and they perform well in softer materials such as polyurethane, while melanin pigments can be easily made water-soluble and they can be readily incorporated in water-soluble polymeric host material such as polyvinyl alcohol.

In a simplest embodiment according to a second aspect of the present invention, a hydrophobic polymer film containing photochromic dye(s) is bonded to another hydrophobic polymer film containing melanin dye to form a two-layer lamination structure. There is usually an adhesive or binding layer between the two dye-containing functional layers. An example of this embodiment is a structure comprising a melanin-containing polycarbonate sheet coated with a photochromic polyurethane hard coating. An example melanin-containing polycarbonate sheet may be prepared according to a method disclosed in U.S. Pat. No. 6,103,777, which is incorporated herein by reference.

In another embodiment according to the second technical aspect of the present invention, a photochromic functional film and a melanin-containing film are bonded together with or without adhesive or binder, and to the outmost surface of one of the film is bonded a transparent resinous sheet with or without adhesive or binder to form a three-layer lamination structure. An example of this embodiment is a structure comprising a melanin-containing polycarbonate sheet and a thermoplastic polyurethane film containing photochromic dye(s) and a clear polycarbonate sheet in sequence and laminated together.

In yet another embodiment according to the second technical aspect of the present invention, a photochromic functional film and a melanin-containing film are bonded together with or without adhesive or binder, and to the outmost surface of each of the films is bonded a transparent resinous sheet with or without adhesive or binder to form a four-layer lamination structure. An example of this embodiment is a structure comprising a clear polycarbonate sheet, a polyurethane film containing photochromic dye(s), a melanin-containing polyvinyl alcohol film, and a clear polycarbonate sheet, in sequence, and laminated together with urethane type adhesive.

In still another embodiment according to the second technical aspect of the present invention, a melanin-containing film is sandwiched between two photochromic layers, and to the outmost surface of each of the photochromic layer is bonded a transparent resinous sheet with or without adhesive or binder to form a five-layer lamination structure. An example of this embodiment is a lamination structure comprising a clear polycarbonate sheet, a polyurethane film containing photochromic dyes, a melanin-containing polyvinyl alcohol film, another polyurethane film containing photochromic dyes, and a clear polycarbonate sheet, in sequence. The photochromic polyurethane layers in this embodiment also provide adhesion between the polycarbonate sheet and the PVA film.

In either aspect of the present invention, the amount of melanin loaded in an optical plate of the invention is determined by the desired visible light transmission under ambient (indoor) conditions. The indoor visible light transmission is desirably between 40% to 80%, preferably between 50% to 70%, and more preferably between 60% to 75%.

In either aspect of this invention, the amount of photochromic dye(s) loaded in an optical plate of the invention is determined by the desired light blockage in the activated state. The outdoor visible light transmission is desirably between about 5% to 50%, preferably between about 5% to 30%, and more preferably between 10% to 20%. Generally, the amount of total photochromic compounds incorporated into or applied to a photochromic host material may range from about 0.05 to 2.0, e.g., from about 0.2 to 1.0, milligrams per square centimeter of surface area to which the photochromic substance(s) is incorporated or applied. The amount of photochromic material incorporated into a coating composition may range from about 0.1% to 10%, by weight, based on the weight of the liquid coating composition.

In either aspect of this invention, other additives such as colorants, antioxidants, light stabilizers may also be incorporated into the same host layer as the photochromic compounds and/or melanin pigments to achieve certain required performance.

The photochromic melanin-containing optical plate of the present invention can be used as-is in goggles. To incorporate the plate into other type of plastic optical articles such as eyewear lenses, it is usually formed to have a curved wafer having spherical surface. The wafer can then be integrated with the lens base material by insert casting in case of casting resin like CR-39 as described in U.S. Pat. No. 5,286,419, or by insert injection molding in case of polycarbonate as described in U.S. Pat. No. 6,328,446.

### EXAMPLES

The present invention will now be described in more detail in reference to examples, which are for illustration purpose only and should not be construed as a limitation upon the scope of the invention in any way. For anyone who is familiar with the art, it is easy to change the conditions in the examples to affect different film properties.

The transmission spectrum, total visible light transmission (TLT) for a given photochromic melanin-containing optical plate is measured using Hunter Lab UltraScan spectrophotometer.

The activation is done by exposing the photochromic film to a Xenon Solar Simulating Lamp with an intensity of 12 watts/m2 in the 300 nm to 400 nm spectral range, for 5 minutes.

### Example 1

A thermoplastic polyurethane CLC93A obtained from Thermedics Polymer Products (Boston, Mass.) was dissolved in tetrahydrofuran to make a solution containing 25% polyurethane. To the solution was added 0.3%, by weight, of a hydrophobic melanin obtained from Photoprotective Technologies (San Antonio, Tex.), and 2.0% of a gray coloring photochromic dye. The mixture was vigorously stirred for few hours to ensure dissolving of the melanin pigment and the photochromic dye.

The resulting solution was cast on a T50 release liner obtained from CPFilms (Martinsville, Va.). The cast film was dried on a 60° C. hot surface for 5 minutes to yield a 0.075 mm thick photochromic polyurethane film containing melanin. The film was then transfer-laminated between two 0.38 mm (15 mil) thick polycarbonate sheets DFS851 obtained from GE Polymershapes (Huntersville, N.C.) through a hot press laminator.

The photochromic melanin-containing optical plate so obtained had a visible light transmission of 75% at an un-activated state (indoor). The light transmission after activation was 8%, and the color of the plate changed from light brown to gray.

### Example 2

A photochromic melanin-containing optical plate was prepared in according to the procedure in Example 1, except that the melanin concentration was increased to 0.8% and the 2.0% gray photochromic dye was replaced by 1.0% of a brown coloring photochromic dye package consisting of a yellow dye, a ruby (red) dye, and a blue dye.

The optical plate so obtained comprised a 0.035 mm thick photochromic polyurethane film containing melanin, had a visible light transmission of 59% at an un-activated state (indoor). The light transmission after activation was 35%, and the color of the plate changed from light brown to dark brown.

### Example 3

A polyvinyl alcohol film (Kuraray Vinylon™ #7500 film forming polymer) is stretched 3 times while being immersed in a 5% (by weight) melanin (aqueous melanin from Photoprotective Technologies, San Antonio, Tex.) aqueous solution bath at 52° C. for 2.5 minutes. The film is then rinsed with water, air dried, and heat treated at 110° C. for 10 minutes while still under tension, to produce a 0.04 mm (1.6 mil) melanin-containing, light brown polyvinyl alcohol film. The visible light transmission of the film was 65%.

A gray photochromic polyurethane film was prepared as in Example 1, except no melanin was added to the film. A two-component polyurethane adhesive, U-10FL from Loctite (Rocky Hill, Conn.), was used to bond the above films and two 0.38 mm thick polycarbonate sheets in the following structure format: polycarbonate sheet—photochromic polyurethane film—adhesive—melanin polyvinyl alcohol film—adhesive—polycarbonate sheet.

The photochromic melanin-containing optical plate so obtained had a visible light transmission of 62% at an un-activated state (indoor). The light transmission after activation was 8%, and the color of the plate changed from light brown to gray.

1. An ophthalmic article comprising:
a film containing a photochromic substance and a melanin substance and wherein an indoor visible light transmission value of said film is between about 40% to 80% and wherein an outdoor visible light transmission value of said film is between about 5% to about 50%.

2. The ophthalmic article of claim 1 further comprising a resinous sheet adhered to said film.

3. The ophthalmic article of claim 1 further comprising two resinous sheets, each adhered to opposite sides of said film, said film including an adhesive.

4. The ophthalmic article of claim 1 wherein said film is polyurethane.

5. The ophthalmic article of claim 1 wherein said film is polyvinyl alcohol.

6. The ophthalmic article of claim 1 wherein said photochromic compound is a naphthopyran derivative.

7. An optical plate comprising:
a first film containing a photochromic substance; and,
a second film containing a melanin substance;
said optical plate having an indoor visible light transmission value of between about 40% to 80% and an outdoor visible light transmission value of between about 5% to about 50%.

8. The optical plate of claim 7 further comprising a third film containing a second photochromic compound;
said second film interposed between said first and said third film.

9. The optical plate of claim 7 wherein said first and second film are bonded together and further comprising a resinous layer disposed on an exposed side of each of said first and second films.

10. The optical plate of claim 7 wherein said first and second films are bonded together and wherein a resinous layer is disposed on the exposed side of at least one of said first and second film.

11. The optical plate of claim 7 wherein said first film is comprised of polyurethane and said second film is comprised of polyvinyl alcohol.

12. The optical plate of claim 9 wherein said resinous layer comprises a polycarbonate homopolymer, a copolymer, or a blending of the two.

13. The optical plate of claim 10 wherein said resinous layer comprises a polycarbonate homopolymer, a copolymer, or a blending of the two.

14. A method of creating eye article comprising:
obtaining a host material;
dissolving a melanin compound and a photochromic dye into said host material; and,
allowing said host material to solidify.

15. The method of creating eye article wherein said article has an indoor visible light transmission value of between about 40% to 80% and an outdoor visible light transmission value of between about 5% to about 50%.

16. A method as set forth in claim 14 further comprising:
placing said solidified host material into an injection mold;
injecting molten resinous material against said host material in said mold; and,
allowing said molten resinous material to harden and thereby providing an eye lens.

17. A method as set forth in claim 14, further comprising using said solidified host material to form a cast eye lens.

18. A method of creating an eye article comprising:
obtaining a first host material;
dissolving a melanin compound in said first host material;
obtaining a second host material;
dissolving a photochromic dye into said second host material; and,
combining said first host material and said second host material.

19. A method as set forth in claim 18, further comprising using said combined first and second host material to form an injection molded eye lens.

20. A method as set forth in claim 18, further comprising using said combined first and second host material to form cast eye lens.

21. A method according to claim 18 wherein the combining of said first and second host materials includes forming a film having an indoor visible light transmission value of between about 40% to 80% and an outdoor visible light transmission value of between about 5% to about 50%.
